(19) United States
(12) Patent Application Publication
(10) Pub. No.: US 2022/0320662 A1
(43) Pub. Date: Oct. 6, 2022

(54) VEHICULAR BATTERY CASE

(71) Applicant: AISIN CORPORATION, Kariya (JP)

(72) Inventors: Masato OISHI, Kariya-shi (JP); Hiroshi OKAZAKI, Kariya-shi (JP); Kanna NAGATSUKA, Kariya-shi (JP)

(73) Assignee: AISIN CORPORATION, Kariya (JP)

(21) Appl. No.: 17/692,682

(22) Filed: Mar. 11, 2022

(30) Foreign Application Priority Data
Mar. 30, 2021 (JP) 2021-057838

(51) Int. Cl. H01M 50/242; B60K 1/04; H01M 50/209; H01M 50/249

(52) U.S. Cl. CPC H01M 50/242; B60K 1/04; H01M 50/209; H01M 50/249; H01M 2220/20

(57) ABSTRACT

Each of left and right side frames of a battery case enabling enhanced tolerance to a side-impact collision includes a side wall part being provided on a side on which the side frames face each other and an EA part being provided on the opposite side. The EA part includes an EA upper plate part and an EA lower plate part being vertically separated from each other. Top surfaces and bottom surfaces of the plate parts are plate-shaped parts perpendicular to the vertical direction. The side wall part includes a first rib-like part and a second rib-like part being vertically separated from each other. Top surfaces and bottom surfaces of the rib-like parts are plate-shaped parts perpendicular to the vertical direction. Extensions of center lines of the EA upper and lower plate parts in a thickness direction pass through insides of the first and second rib-like parts, respectively.

### CROSS REFERENCE TO RELATED APPLICATIONS

This application is based on and claims priority under 35 U.S.C. § 119 to Japanese Patent Application 2021-057838, filed on Mach 30, 2021, the entire content of which is incorporated herein by reference.

### TECHNICAL FIELD

This disclosure generally relates to a vehicular battery case.

### BACKGROUND DISCUSSION

A battery case housing a battery of an electrically powered vehicle [such as an EV, a plug-in hybrid vehicle (PHV), or a hybrid vehicle (HV)] is placed, for example, in a lower part of the vehicle and between rocker panels. Further, an electrically powered vehicle is required to protect a battery when a side-impact collision occurs. For this reason, JP2019-110003A (Reference 1) discloses a lower structure of a vehicle being provided with impact absorption parts inside left and right rocker panels in a vehicle widthwise direction. Then, a battery case is placed between the impact absorption parts. Such a structure allows absorption of energy of a side-impact collision by the impact absorption parts provided on the rocker panels and therefore allows reduction of impact applied to a battery housed in the battery case.

However, when the impact absorption part of the rocker panel is deformed by a side-impact collision in such a way as to get inside in the vehicle widthwise direction in the lower structure of a vehicle disclosed in Reference 1, impact may be applied to the battery by the impact absorption part coming in contact with a side wall part of the battery case. Further, when the side wall part of the battery case is deformed, the deformed side wall part of the battery case may collide with the battery and damage the battery. Thus, the lower structure of a vehicle disclosed in Reference 1 may not be able to sufficiently protect the battery during a side-impact collision.

A need thus exists for a vehicular battery case which is not susceptible to the drawback mentioned above.

### SUMMARY

In order to solve the aforementioned problem, a vehicular battery case according to this disclosure includes two side frames. The two side frames are separately placed in a first direction, extend in a second direction perpendicular to the first direction, and allow a battery to be housed in between. Each of the two side frames includes an energy absorption part and a side wall part. A space is formed inside the energy absorption part. The side wall part is provided on a vicinity side being a side closer to the counterpart side frame than the energy absorption part. A space is formed inside the side wall part. The energy absorption part includes a first plate-shaped part and a second plate-shaped part. The first plate-shaped part and the second plate-shaped part are separated from each other in a third direction perpendicular to the first direction and the second direction and extend in the first direction and the second direction. The side wall part includes a third plate-shaped part, a fourth plate-shaped part, a first rib-like part, and a second rib-like part. The third plate-shaped part extends in a direction crossing the first direction and in the second direction and is coupled with ends of the first plate-shaped part and the second plate-shaped part on the vicinity side. The fourth plate-shaped part extends in a direction crossing the first direction and in the second direction and is placed separately from the third plate-shaped part on the vicinity side of the third plate-shaped part. The first rib-like part and the second rib-like part extend in the first direction and the second direction. Ends of the first rib-like part and the second rib-like part on the vicinity side are coupled with the third plate-shaped part. Ends of the first rib-like part and the second rib-like part on an opposite side of the ends on the vicinity side are coupled with the fourth plate-shaped part. When viewed from the second direction, an extension of a center line of the first plate-shaped part in a thickness direction passes through an inside of the first rib-like part. An extension of a center line of the second plate-shaped part in a thickness direction passes through an inside of the second rib-like part.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exterior perspective view illustrating a structure of a battery case according to an embodiment of this disclosure;

FIG. 2 is an exterior perspective view illustrating the structure of the battery case according to the embodiment of this disclosure and is a diagram illustrating a state in which a battery is housed;

FIG. 3 is an exploded perspective view illustrating the structure of the battery case according to the embodiment of this disclosure;

FIG. 4 is a perspective view illustrating a structure of a cross; and

FIG. 5 is a cross-sectional view illustrating the structure of the battery case according to the embodiment of this disclosure.

### DETAILED DESCRIPTION

An embodiment disclosed here will be described below. In the following description, a vehicular battery case 10 according to the embodiment of this disclosure is simply abbreviated to a “battery case 10.” In the following description, each direction used for the battery case 10 and members constituting the battery case 10 is based on a direction in a state of being installed on a vehicle (that is, a direction of the vehicle). In each diagram, the front side of the battery case 10 is indicated by an arrow Fr, the rear side by an arrow Rr, the upper side by an arrow Up, the lower side by an arrow Dw, the right side by an arrow R, and the left side by an arrow L.

The battery case 10 is used for housing a battery mounted on an electrically powered vehicle [such as an EV, a plug-in hybrid vehicle (PHV), or a hybrid vehicle (HV)]. Then, the battery case 10 is placed on the floor of the vehicle (below seats).

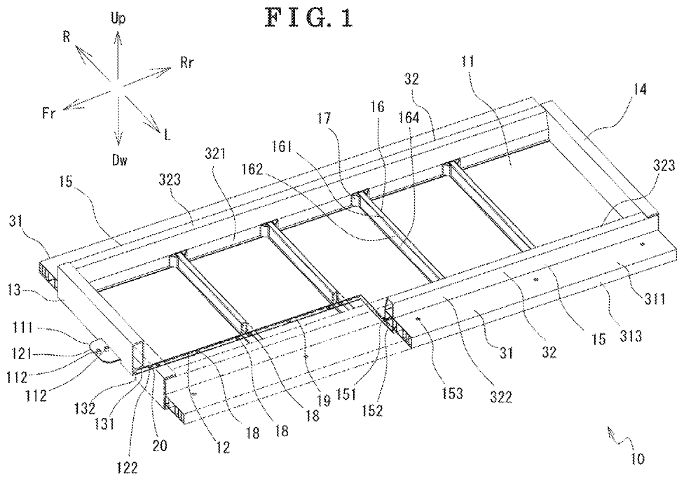

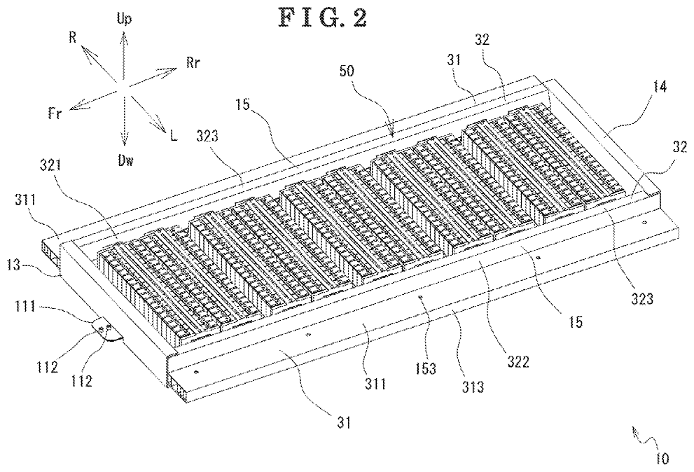

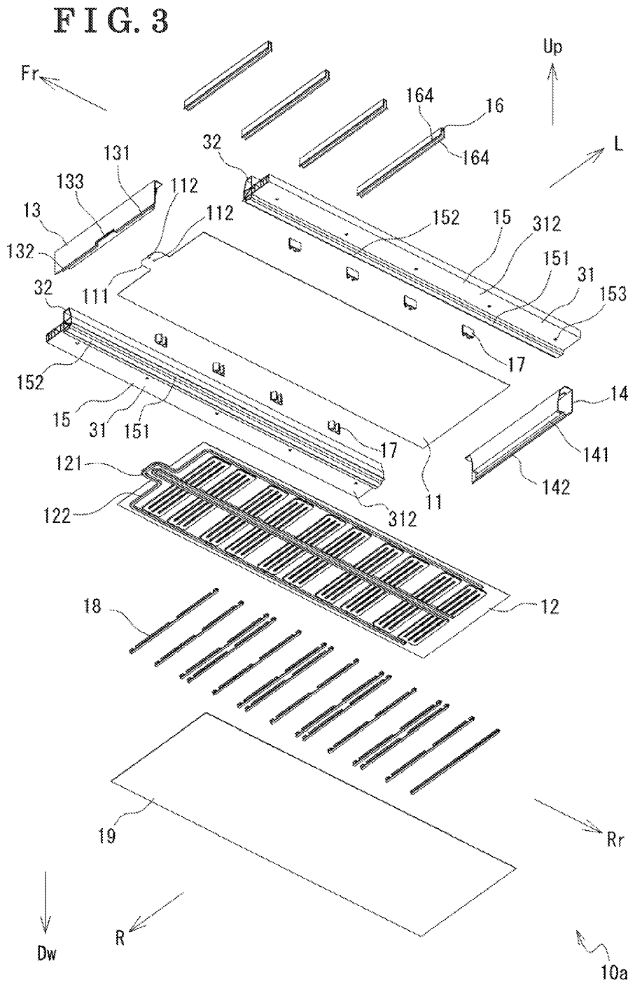

First, an overall structure of the battery case 10 will be described. FIG. 1 is a perspective view illustrating a structure of the battery case 10. FIG. 2 is a diagram illustrating the structure of the battery case 10 and is a diagram illustrating a state of a battery module 50 being housed. FIG. 3 is an exploded perspective view illustrating the structure of the battery case 10 and is a diagram viewed from below.

As illustrated in FIG. 1 to FIG. 3, the battery case 10 includes a lower panel 11, a heat sink 12, a front frame 13, a rear frame 14, two side frames 15 on the left and right, a plurality of crosses 16, a plurality of cross support members 17, a plurality of lower frames 18, and a shared panel 19. The battery case 10 is almost a quadrilateral when viewed from the vertical direction and has a bottomed box shaped structure the upper side of which is open. Specifically, the lower panel 11, the heat sink 12, the lower frame 18, and the shared panel 19 form the “bottom of the box,” and the front frame 13, the rear frame 14, and the left and right side frames 15 form “side walls of the box.” Further, the front frame 13, the rear frame 14, and the left and right side frames 15 form an almost quadrilateral frame body having an opening on the inner circumferential side when viewed from the vertical direction.

Then, an area being on the top surface side of the lower panel 11 and being surrounded by the front frame 13, the rear frame 14, and the left and right side frames 15 (that is, the inside of an opening of the frame body formed by the front frame 13, the rear frame 14, and the left and right side frames 15) is an area where the battery module 50 can be housed. The two side frames 15 on the left and right are placed outside the area where the battery module 50 can be housed on the left and right, respectively, the longitudinal direction of the frames being a direction parallel to a lengthwise direction. Specifically, the left and right side frames 15 are placed separately from each other in a transverse direction being an example of a first direction and extend in the lengthwise direction being an example of a second direction. For convenience of description, a side of each of the left and right side frames 15 closer to the counterpart (a side of the area where the battery module 50 can be housed) is referred to as a “vicinity side.” The plurality of crosses 16 are placed side by side in the lengthwise direction, the longitudinal direction of the crosses being a direction parallel to the transverse direction. Then, end surfaces of each cross 16 in the longitudinal direction (the transverse direction) face sides of the left and right side frames 15 on the vicinity side (that is, surfaces of the left and right side frames 15 facing each other and more specifically, surfaces of side wall inner circumferential plate parts 321 on the vicinity side) in close vicinity thereto, respectively. Note that an end of the cross 16 in the longitudinal direction may be in contact with the side frame 15.

Next, each member in the battery case 10 will be described.

The lower panel 11 and the heat sink 12 are examples of a bottom plate member, and each of the lower panel 11 and the heat sink 12 is an almost quadrilateral plate-shaped member when viewed from the vertical direction. Further, the lower panel 11 and the heat sink 12 have almost the same shape and almost the same size when viewed from the vertical direction. For example, each of the lower panel 11 and the heat sink 12 is molded from an aluminum plate.

Extension parts 111 and 121 extending forward are provided in central parts of the front ends (front sides) of the lower panel 11 and the heat sink 12 in the transverse direction, respectively. Two supply-discharge parts 112 are provided on the extension part 111 of the lower panel 11. The two supply-discharge parts 112 are holes connecting the inside and the outside of a temperature control channel 20 provided between the lower panel 11 and the heat sink 12. The temperature control channel 20 is a channel through which a temperature control fluid (such as water) for temperature control of the battery module 50 can flow. Supply of the temperature control fluid to the temperature control channel 20 and discharge of the temperature control fluid from the temperature control channel 20 can be performed through the two supply-discharge parts 112.

A channel wall part 122 forming the temperature control channel 20 is provided on the heat sink 12. The channel wall part 122 is a cavity the upper side of which is open and is molded by pressing. Therefore, the channel wall part 122 bulges downward.

The heat sink 12 is placed on and below the lower panel 11 and is joined to the lower panel 11. Then, when the heat sink 12 and the lower panel 11 are joined to each other, the channel wall part 122 formed on the heat sink 12 is lidded by the lower panel 11. Accordingly, the temperature control channel 20 through which a temperature control fluid can flow is formed between the lower panel 11 and the heat sink 12 (in other words, inside a laminated body of the lower panel 11 and the heat sink 12).

Each of the front frame 13, the rear frame 14, and the left and right side frames 15 is a hollow and long bar-shaped member. An aluminum extruded material is applied to each of the front frame 13, the rear frame 14, and the left and right side frames 15.

The front frame 13 and the rear frame 14 are placed separately from each other in parallel in the lengthwise direction, the longitudinal direction of the frames being a direction parallel to the transverse direction (vehicle widthwise direction). First joint surfaces 131 and 141 to which the lower panel 11 (the laminated body of the lower panel 11 and the heat sink 12) is joined and second joint surfaces 132 and 142 to which the shared panel 19 is joined are formed in lower parts of the front frame 13 and the rear frame 14, respectively. Each of the first joint surfaces 131 and 141 and the second joint surfaces 132 and 142 is a plane being long in the transverse direction, being perpendicular to the vertical direction, and facing downward.

The first joint surfaces 131 and 141 and the second joint surfaces 132 and 142 on the front frame 13 and the rear frame 14 are displaced from each other in the lengthwise direction and the vertical direction and do not overlap each other when viewed from the vertical direction. Further, the second joint surfaces 132 and 142 on the front frame 13 and the rear frame 14 are positioned on the lower side of the first joint surfaces 131 and 141. Specifically, protruding parts protruding downward are provided on the bottom surfaces of the front frame 13 and the rear frame 14, respectively, in such a way as to extend in the transverse direction along sides opposite to sides on which the front frame 13 and the rear frame 14 face each other. Then, the bottom surfaces of parts not being the protruding parts are the first joint surfaces 131 and 141, respectively, and the bottom surfaces of the protruding parts are the second joint surfaces 132 and 142, respectively. The first joint surface 131 of the front frame 13 is positioned on the rear side of the second joint surface 132, and the first joint surface 141 of the rear frame 14 is positioned on the front side of the second joint surface 142. Specifically, the first joint surfaces 131 and 141 are positioned on the inner circumferential side of the quadrilateral frame body formed by the front frame 13, the rear frame 14, and the left and right side frames 15 relative to the second joint surfaces 132 and 142. Further, the second joint surfaces 132 and 142 are positioned on the lower side of the first joint surfaces 131 and 141.

A recessed part 133 for avoiding interference with the extension parts 111 and 121 of the lower panel 11 and the heat sink 12 is provided in the lower part of the front frame 13. The lower side of the recessed part 133 is opened in such a way as to allow installation of the lower panel 11 and the heat sink 12 from the lower side of the front frame 13.

The left and right side frames 15 are placed separately from each other in parallel in the transverse direction, the longitudinal direction of the frames being a direction parallel to the lengthwise direction. Each of the left and right side frames 15 includes an energy absorption part 31 (hereinafter denoted by an “EA part 31”) inside which a space is formed and a side wall part 32 positioned on one side (specifically, a side on which the left and right side frames 15 face each other) of the EA part 31, a space being formed inside the side wall part 32. Then, a first joint surface 151 to which the lower panel 11 (the laminated body of the lower panel 11 and the heat sink 12) is joined and a second joint surface 152 to which the shared panel 19 is joined are provided in the lower part of the side wall part 32 of each of the left and right side frames 15. Each of the first joint surface 151 and the second joint surface 152 is a plane being long in the longitudinal direction, being perpendicular to the vertical direction, and facing downward. Details of the structure of the left and right side frames 15 will be described later.

The plurality of crosses 16 have a function of enhancing rigidity of the battery case 10. Then, by receiving a load in the transverse direction when a side-impact collision or the like occurs, the crosses 16 prevent or suppress the side frame 15 being deformed and coming in contact with the battery module 50. Each of the plurality of crosses 16 is a long bar-shaped member and, for example, an aluminum extruded material is applied to the cross 16. The plurality of crosses 16 extend in a bar shape along the top surface of the lower panel 11 and are placed side by side in the lengthwise direction, the longitudinal direction of the crosses 16 being a direction parallel to the transverse direction.

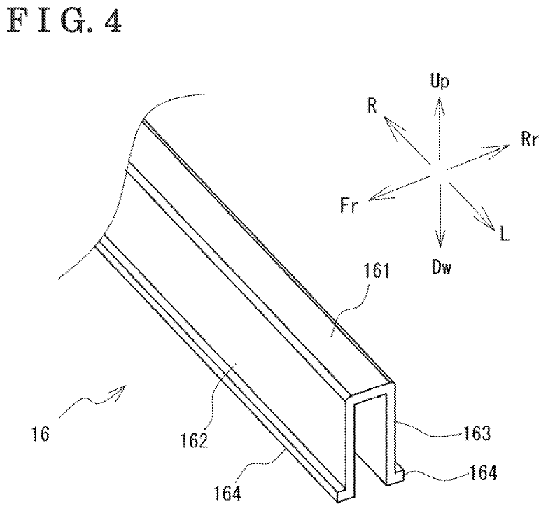

FIG. 4 is a perspective view illustrating a structure of the cross 16. As illustrated in FIG. 4, the cross 16 has an almost quadrilateral sectional shape the lower end of which is open (that is, an open sectional shape). Specifically, the cross 16 includes a flat-plate-shaped cross upper plate part 161 extending in the lengthwise direction and the transverse direction, a flat-plate-shaped cross front plate part 162 and a flat-plate-shaped cross rear plate part 163 extending downward from both ends of the cross upper plate part 161 in the lengthwise direction, respectively, and extending in the transverse direction. The cross upper plate part 161 is an example of a plate-shaped part of the cross 16. Furthermore, flange parts 164 extending to sides opposite to each other in the lengthwise direction are provided at the lower ends of the cross front plate part 162 and the cross rear plate part 163, respectively, across the entire length of the cross 16 in the longitudinal direction (that is, the transverse direction). A surface on the lower side of the flange part 164 is a plane perpendicular to the vertical direction (in other words, parallel to the top surface of the lower panel 11).

The cross support member 17 is a member for fixing each of the two ends of each cross 16 in the longitudinal direction to each of the left and right side frames 15. For example, an aluminum extruded material is applied to the cross support member 17. A specific structure of the cross support member 17 is not particularly limited. Each cross support member 17 has only to be formed in such a way as to be able to fix each of the two ends of each cross 16 to each of the left and right side frames 15.

The lower frame 18 is a long bar-shaped member. An aluminum extruded material is applied to the lower frame 18. The top surface and the bottom surface of the lower frame 18 are planes perpendicular to the vertical direction and are parallel to each other. Further, a recessed part for avoiding interference with the channel wall part 122 of the heat sink 12 is provided on the top surface side of the lower frame 18. The sectional shape of the lower frame 18 is not particularly limited.

The shared panel 19 is an almost quadrilateral plate-shaped member when viewed from the vertical direction. For example, an aluminum plate is applied to the shared panel 19. The lengths of the shared panel 19 in the lengthwise direction and the transverse direction are greater than the lengths of each of the lower panel 11 and the heat sink 12 excluding the extension parts 111 and 121 in the lengthwise direction and the transverse direction, respectively.

Next, an installation structure of the battery case 10 will be described.

Ends of each of the front frame 13 and the rear frame 14 in the longitudinal direction are joined to ends of each of the left and right side frames 15 in the longitudinal direction. Thus, an almost quadrilateral frame body having an opening on the inner circumferential side when viewed from the vertical direction is formed. Then, the plurality of crosses 16 are placed inside the opening of the frame body, the longitudinal direction of the crosses 16 being a direction almost parallel to the longitudinal direction of the front frame 13 and the rear frame 14. Therefore, end surfaces of each cross 16 in the longitudinal direction face the left and right side frames 15 in close vicinity to the side frames 16, respectively. Then, both ends of each cross 16 are joined to the left and right side frames 15, respectively, through the cross support members 17.

The lower panel 11 and the heat sink 12 are placed below the front frame 13, the rear frame 14, and the left and right side frames 15. At this time, the outer circumferential parts of the lower panel 11 and the heat sink 12 overlap the lower sides of the first joint surfaces 131, 141, and 151 of the front frame 13, the rear frame 14, and the left and right side frames 15. Then, the outer circumferential parts of the lower panel 11 and the heat sink 12 are joined to the first joint surfaces 131, 141, and the 151 of the front frame 13, the rear frame 14, and the left and right side frames 15. Furthermore, the flange part 164 of the cross 16 is joined to the lower panel 11.

The plurality of lower frames 18 are placed below the lower panel 11 and the heat sink 12. Specifically, the plurality of lower frames 18 are placed separately from each other in the lengthwise direction, the longitudinal direction of the lower frames 18 being a direction parallel to the longitudinal direction of the front frame 13 and the rear frame 14. Then, the upper end (top surface) of each lower frame 18 is joined to the bottom surface of the heat sink 12.

The shared panel 19 is placed below the lower panel 11, the heat sink 12, the left and right side frames 15, and the plurality of lower frames 18. The outer circumferential part of the shared panel 19 overlaps the lower side of the second joint surfaces 132, 142, and 152 of the front frame 13, the rear frame 14, and the left and right side frames 15. Further, the lower end (bottom surface) of each lower frame 18 is in contact with the top surface of the shared panel 19. Then, the outer circumferential part of the shared panel 19 is joined to the second joint surfaces 132, 142, and 152 of the front frame 13, the rear frame 14, and the left and right side frames 15. Furthermore, the lower end of each lower frame 18 is joined to the shared panel 19.

For example, laser welding is applied to joining of members constituting the battery case 10.

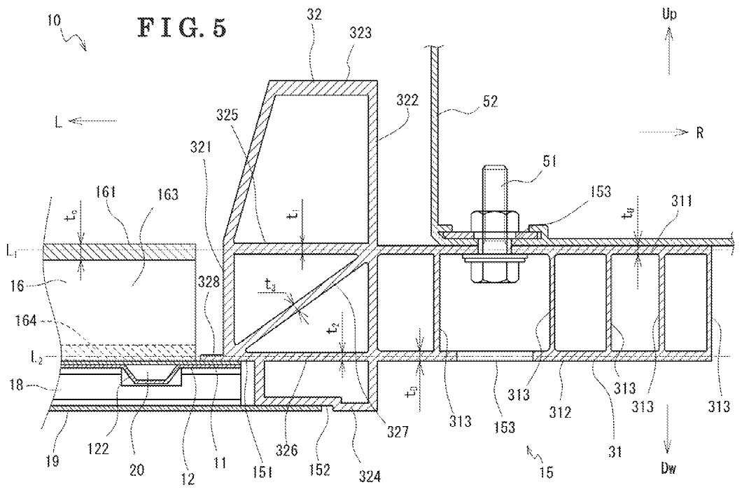

Next, details of the structure of the side frame 15 and a relation between the side frame 15 and other members will be described. FIG. 5 is a cross-sectional view when the battery case 10 is cut by a plane perpendicular to the lengthwise direction.

As illustrated in FIG. 5, each of the left and right side frames 15 includes the EA part 31 and the side wall part 32. The EA part 31 is positioned on one side of the side wall part 32 (specifically, the opposite side of the area where the battery module 50 can be housed, in other words, on the outer circumferential side of the frame body formed by the front frame 13, the rear frame 14, and the left and right side frames 15). The EA part 31 and the side wall part 32 are integrated.

The EA part 31 has a hollow bar-shaped structure being long in the lengthwise direction. The EA part 31 is formed in such a way as to, when a side-impact collision or the like occurs, absorb energy of impact caused by the side-impact collision or the like by deformation and reduce impact applied to the battery module 50. As illustrated in FIG. 5, the EA part 31 includes an EA upper plate part 311 being an example of a first plate-shaped part, an EA lower plate part 312 being an example of a second plate-shaped part, and a plurality of (five in FIG. 5) EA vertical plate parts 313.

Each of the EA upper plate part 311 and the EA lower plate part 312 is a flat-plate-shaped part extending in the lengthwise direction and the transverse direction. The EA upper plate part 311 and the EA lower plate part 312 are separated in the vertical direction being an example of a third direction. A bolt insertion hole 153 for inserting a bolt 51 for bolting the EA part 31 to a rocker panel 52 of the vehicle is provided on each of the EA upper plate part 311 and the EA lower plate part 312. The bolt insertion hole 153 is a through hole for penetrating the EA upper plate part 311 and the EA lower plate part 312 in the vertical direction. Each of the plurality of EA vertical plate parts 313 is a flat-plate-shaped part extending in the lengthwise direction and the vertical direction. The plurality of EA vertical plate parts 313 are separated from each other in the transverse direction. Then, the upper ends of the plurality of EA vertical plate parts 313 are connected to the EA upper plate part 311, and the lower ends of the plurality of EA vertical plate parts 313 are connected to the EA lower plate part 312. A sectional shape of the EA part 31 being cut by a plane perpendicular to the lengthwise direction is a rectangle being long in the transverse direction, the top surface and the bottom surface of the rectangle being almost horizontal.

The side wall part 32 is provided on the vicinity side of the EA part 31. A section of the side wall part 32 being cut by a plane perpendicular to the lengthwise direction is a vertically oriented shape. Then, the side wall part 32 has a hollow bar-shaped structure being long in the lengthwise direction. The side wall part 32 includes a side wall inner circumferential plate part 321 being an example of a fourth plate-shaped part, a side wall outer circumferential plate part 322 being an example of a third plate-shaped part, a side wall upper plate part 323, a side wall lower plate part 324, a first rib-like part 325, a second rib-like part 326, and a third rib-like part 327.

Each of the side wall inner circumferential plate part 321 and the side wall outer circumferential plate part 322 is a plate-shaped part extending in a direction crossing the transverse direction (such as the vertical direction) and in the lengthwise direction. According to the present embodiment, the lower part of the side wall inner circumferential plate part 321 (specifically, a part below the first rib-like part 325 to be described later) has a flat-plate-shaped structure extending in the vertical direction and the lengthwise direction, and the upper part of the side wall inner circumferential plate part 321 (a part above the first rib-like part 325) has a flat-plate-shaped structure extending in a direction tilted relative to the vertical direction and in the lengthwise direction. Further, the side wall outer circumferential plate part 322 has a flat-plate-shaped structure extending in the vertical direction and the lengthwise direction. The side wall inner circumferential plate part 321 and the side wall outer circumferential plate part 322 are separated from each other in the transverse direction. Then, the side wall inner circumferential plate part 321 is positioned on the vicinity side (a side closer to the area where the battery module 50 is housed) of the side wall outer circumferential plate part 322. Furthermore, the side wall outer circumferential plate part 322 is integrated with one end of each of the EA upper plate part 311 and the EA lower plate part 312 of the EA part 31 in the transverse direction (an end closer to one of the sides of the two side frames 15 facing each other).

Each of the side wall upper plate part 323 and the side wall lower plate part 324 is a plate-shaped part extending in the transverse direction and the lengthwise direction. The side wall upper plate part 323 and the side wall lower plate part 324 are separated from each other in the vertical direction. The side wall upper plate part 323 is a part provided in such a way as to connect the upper end (upper side) of the side wall inner circumferential plate part 321 to the upper end (upper side) of the side wall outer circumferential plate part 322. The side wall lower plate part 324 is a part provided in such a way as to connect the lower end (lower side) of the side wall inner circumferential plate part 321 to the lower end (lower side) of the side wall outer circumferential plate part 322.

The first joint surface 151 and the second joint surface 152 are provided in the lower part of the side wall part 32 of the side frame 15. A structure of each of the first joint surface 151 and the second joint surface 152 is a plane being long in the longitudinal direction, being perpendicular to the vertical direction, and facing downward. Further, the first joint surface 151 and the second joint surface 152 are positioned differently from each other in the vertical direction, and the second joint surface 152 is positioned below the first joint surface 151. Specifically, as illustrated in FIG. 5, the bottom surface of a part extending to the opposite side of the vicinity side from the lower end of the side wall inner circumferential plate part 321 of the side frame 15 (part of the second rib-like part 326 to be described later) and the bottom surface of a plate-shaped extension part 328 extending to the vicinity side from the lower end of the side wall inner circumferential plate part 321 form an integrated plane. The integrated plane is the first joint surface 151. The second joint surface 152 is provided on the side wall outer circumferential plate part 322 side of the first joint surface 151 and below the first joint surface 151.

The first rib-like part 325, the second rib-like part 326, and the third rib-like part 327 are provided inside the side wall part 32 of the side frame 15 (an area surrounded by the side wall inner circumferential plate part 321, the side wall outer circumferential plate part 322, the side wall upper plate part 323, and the side wall lower plate part 324).

Each of the first rib-like part 325 and the second rib-like part 326 is a flat-plate-shaped part extending in the lengthwise direction and the transverse direction. One end of each of the first rib-like part 325 and the second rib-like part 326 in the transverse direction (an end on the vicinity side, that is, an end on the L side in FIG. 5) is connected to the side wall inner circumferential plate part 321, and an end on the opposite side of the one end (an end on the R side in FIG. 5) is connected to the side wall outer circumferential plate part 322. In other words, the first rib-like part 325 and the second rib-like part 326 are provided in such a way as to connect the side wall inner circumferential plate part 321 to the side wall outer circumferential plate part 322 inside the side wall part 32. The first rib-like part 325 and the second rib-like part 326 are separated in the vertical direction (positioned differently from each other in the vertical direction), and the second rib-like part 326 is positioned below the first rib-like part 325.

As illustrated in FIG. 5, part of the bottom surface of the second rib-like part 326 forms the first joint surface 151. However, the bottom surface of the second rib-like part 326 and the first joint surface 151 may be different surfaces. For example, the bottom surface of the second rib-like part 326 may be positioned below the first joint surface 151, and the top surface of the second rib-like part 326 may be positioned above the first joint surface 151.

The first rib-like part 325 is positioned on the upper side of the laminated body of the lower panel 11 and the heat sink 12. On the other hand, the vertical position of the second rib-like part 326 is the same (or almost the same) as the vertical position of the laminated body of the lower panel 11 and the heat sink 12. Therefore, the vertical distance from the joint of the laminated body of the lower panel 11 and the heat sink 12, and the side wall part 32 (the first joint surface 151) to the first rib-like part 325 is greater than the vertical distance from the joint of the laminated body of the lower panel 11 and the heat sink 12, and the side wall part 32 to the second rib-like part 326 (0 or almost 0 in the present embodiment). The first rib-like part 325 and the second rib-like part 326 may be positioned on the upper side of the laminated body of the lower panel 11 and the heat sink 12 in terms of the vertical direction. Even in this case, the vertical distance from the joint of the laminated body of the lower panel 11 and the heat sink 12, and the side wall part 32 (the first joint surface 151) to the first rib-like part 325 is greater than the vertical distance from the joint of the laminated body of the lower panel 11 and the heat sink 12, and the side wall part 32 to the second rib-like part 326.

As illustrated in FIG. 5, in a section being cut by a plane perpendicular to the lengthwise direction, an extension L₁ (hereinafter denoted by a “first reference line L₁”) of a center line of the EA upper plate part 311 in the thickness direction (a center line relative to the top surface and the bottom surface of the EA upper plate part 311, the center line practically being a plane extending in the lengthwise direction and the transverse direction) passes between the top surface and the bottom surface of the first rib-like part 325 of the side wall part 32 (in other words, inside the first rib-like part 325). Similarly, in a section being cut by a plane perpendicular to the lengthwise direction, an extension L₂ (hereinafter denoted by a “second reference line L₂”) of a center line of the EA lower plate part 312 in the thickness direction (a center line relative to the top surface and the bottom surface of the EA lower plate part 312) passes between the top surface and the bottom surface of the second rib-like part 326 (in other words, inside the second rib-like part 326). In other words, the first rib-like part 325 and the EA upper plate part 311 include parts overlapping each other when viewed from the transverse direction. Similarly, the second rib-like part 326 and the EA lower plate part 312 include parts overlapping each other when viewed from the transverse direction.

Such a structure enables enhanced rigidity of the side frame 15. Specifically, when external force from the outside in the vehicle widthwise direction toward the inside (force from the right side toward the left side in FIG. 5) is applied to the EA part 31 by a side-impact collision or the like, the external force is transmitted to the side wall part 32 through the EA upper plate part 311 and the EA lower plate part 312. Then, since the first reference line L₁ passes through the inside of the first rib-like part 325 and the second reference line L₂ passes through the inside of the second rib-like part 326, the external force transmitted to the side wall part 32 through the EA upper plate part 311 and the EA lower plate part 312 is directly received by the first rib-like part 325 and the second rib-like part 326 of the side wall part 32. The first rib-like part 325 and the second rib-like part 326 extend in a direction almost parallel to the acting direction of the external force and therefore are resistant to deformation by the external force. Therefore, deformation of the side wall part 32 can be prevented or suppressed compared with a structure not being provided with the first rib-like part 325 and the second rib-like part 326. Specifically, rigidity of the side frame 15 can be enhanced.

Furthermore, since the bottom surface of the second rib-like part 326 is part of the first joint surface 151, the second rib-like part 326 is directly joined to the laminated body of the lower panel 11 and the heat sink 12. Accordingly, external force applied to the second rib-like part 326 can be directly (in other words, without another member or the like in between) received by the laminated body of the lower panel 11 and the heat sink 12, and the lower frame 18. Therefore, rigidity of the battery case 10 can be enhanced compared with a structure in which the second rib-like part 326 is not directly joined to the laminated body of the lower panel 11 and the heat sink 12.

Further, a thickness t₁ of the first rib-like part 325 of the side wall part 32 is greater than a thickness t_{U} of the EA upper plate part 311. Such a structure enables rigidity of the first rib-like part 325 of the side wall part 32 to be more enhanced than rigidity of the EA upper plate part 311 and therefore enables enhanced rigidity of the side wall part 32 compared with the EA part 31. Therefore, when force in the transverse direction is applied to the EA part 31 due to occurrence of a side-impact collision or the like, deformation of the side wall part 32 can be prevented or suppressed while absorbing energy by the EA part 31. Accordingly, such a structure enables reduction of impact applied to the battery module 50 and enables prevention or suppression of damage of the battery module 50 due to the deformed side wall part 32 by preventing or suppressing deformation of the side wall part 32. The first rib-like part 325 is positioned above the laminated body of the lower panel 11 and the heat sink 12, and the lower frame 18. In such a structure, force transferred from the EA upper plate part 311 to the first rib-like part 325 is not directly transferred to the laminated body of the lower panel 11 and the heat sink 12, and the lower frame 18. In other words, the force transferred from the EA upper plate part 311 to the first rib-like part 325 cannot be directly received. Therefore, enhanced rigidity of the first rib-like part 325 is preferable for enhanced rigidity of the side wall part 32. The thickness t₁ of the first rib-like part 325 being greater than the thickness t_{U} of the EA upper plate part 311 enables enhanced rigidity of the side wall part 32, according to the present embodiment.

Further, the thickness t₁ of the first rib-like part 325 is greater than a thickness t₂ of the second rib-like part 326. Such a structure prevents or suppresses the side wall part 32 being deformed in such a way as to fall on the battery module 50 side when a side-impact collision or the like occurs. Specifically, when external force toward the center side in the transverse direction is applied to the side wall part 32 through the EA part 31 in a case of the thickness t₂ of the second rib-like part 326 being less than the thickness t₁ of the first rib-like part 325, the second rib-like part 326 is more likely to be deformed in such a way as to collapse in the transverse direction than the first rib-like part 325. Then, when the second rib-like part 326 is deformed in such a way as to collapse in the transverse direction and the first rib-like part 325 is not deformed, or when an amount of deformation of the second rib-like part 326 when being deformed in such a way as to collapse in the transverse direction is greater than an amount of deformation of the first rib-like part 325, the side wall part 32 is deformed in such a way that the upper part of the side wall part 32 falls on the outer circumferential side (a side opposite to the side on which the battery module 50 is housed). Accordingly, the side wall part 32 coming in contact with the battery module 50 can be prevented or suppressed.

The thickness t₂ of the second rib-like part 326 of the side wall part 32 is less than a thickness t_{D} of the EA lower plate part 312. Such a structure prevents or suppresses the side wall part 32 being deformed in such a way as to fall on the battery module 50 side when a side-impact collision or the like occurs. Specifically, when external force is applied to the side wall part 32 through the EA part 31 in a case of the thickness t₂ of the second rib-like part 326 being less than the thickness t_{D} of the EA lower plate part 312, the side wall part 32 is likely to be deformed in such a way as to collapse in the transverse direction with the EA part 31. Then, when the second rib-like part 326 is deformed in such a way as to collapse, the side wall part 32 is deformed in such a way that the upper part of the side wall part 32 falls on the outer circumferential side (a side opposite to the side on which the battery module 50 is housed). Accordingly, the side wall part 32 coming in contact with the battery module 50 can be prevented or suppressed.

The top surface and the bottom surface of the third rib-like part 327 are tilted relative to the vertical direction and the transverse direction. Specifically, ends of the top surface and the bottom surface of the third rib-like part 327 on the vicinity side are tilted in such a way as to be positioned on the lower side of ends on a side opposite to the vicinity side. Then, the end of the third rib-like part 327 on the vicinity side is connected to the coupling part of the side wall inner circumferential plate part 321 and the second rib-like part 326. Further, the end on the opposite side of the end on the vicinity side is connected to the coupling part of the side wall outer circumferential plate part 322 and the first rib-like part 325. In other words, the third rib-like part 327 is provided in such a way as to connect “the coupling part of the side wall inner circumferential plate part 321 and the second rib-like part 326” to “the coupling part of the side wall outer circumferential plate part 322 and the first rib-like part 325.”

The third rib-like part 327 enables further enhanced rigidity of the side wall part 32. Specifically, the third rib-like part 327 can absorb energy by being deformed, and therefore inclusion of the third rib-like part 327 by the side wall part 32 enables increased energy absorbable by the side wall part 32. Therefore, impact applied to the battery module 50 can be reduced.

Furthermore, when force from the outside in the vehicle widthwise direction toward the center side is applied to the EA part 31, the third rib-like part 327 enables prevention or suppression of the side wall part 32 being deformed in such a way as to fall on the battery module 50 side. Specifically, when force from the outside in the vehicle widthwise direction (the opposite side of the vicinity side) toward the center side in the vehicle widthwise direction (the vicinity side) is applied to the EA part 31, force causing the side wall part 32 to move closer to the battery module 50 is applied to the side wall part 32 through the EA part 31. On the other hand, the side wall part 32 is joined to the lower panel 11 (the laminated body of the lower panel 11 and the heat sink 12) and the shared panel 19 at the first joint surface 151 and the second joint surface 152 that are positioned on the lower side of the first rib-like part 325, respectively. Therefore, the aforementioned force acts in such a way as to rotate the side wall part 32 around the first joint surface 151 and the second joint surface 152 in a direction in which the side wall part 32 falls on the battery module 50 side. Then, since the third rib-like part 327 is provided in such a way as to extend over “the coupling part of the first rib-like part 325 and the side wall outer circumferential plate part 322” and “the coupling part of the second rib-like part 326 and the side wall inner circumferential plate part 321,” the aforementioned force is parallel to or almost parallel to the surface direction of the third rib-like part 327, and thus the third rib-like part 327 is resistant to deformation by the aforementioned force. Accordingly, such a structure enables prevention or suppression of the side wall part 32 being deformed in such a way as to fall on the battery module 50 side.

Furthermore, since an end of the third rib-like part 327 on the vicinity side is positioned in the neighborhood of the first joint surface 151 (specifically, immediately above the first joint surface 151), force applied to the third rib-like part 327 can be transferred to the laminated body of the lower panel 11 and the heat sink 12. Specifically, the force applied to the third rib-like part 327 can be received by the laminated body of the lower panel 11 and the heat sink 12. Accordingly, deformation of the battery case 10 can be prevented or suppressed. Specifically, rigidity of the battery case 10 can be enhanced.

A thickness t₃ of the third rib-like part 327 is less than the thickness t₁ of the first rib-like part 325. Such a structure enables prevention or suppression of the side wall part 32 coming in contact with the battery module 50 for a reason similar to that for the structure in which the thickness t₂ of the second rib-like part 326 is less than the thickness t₁ of the first rib-like part 325. The thickness t₃ of the third rib-like part 327 is the same as the thickness t₂ of the second rib-like part 326 or is greater than the thickness t₂ of the second rib-like part 326. When the thickness t₃ of the third rib-like part 327 is the same as the thickness t₂ of the second rib-like part 326 and is less than the thickness t₁ of the first rib-like part 325, the aforementioned action can be exerted. Furthermore, when force from the outside in the vehicle widthwise direction toward the center side is applied to the EA part 31 in a case of the thickness t₃ of the third rib-like part 327 being greater than the thickness t₂ of the second rib-like part 326, the second rib-like part 326 is most likely to be deformed in such a way as to collapse, the third rib-like part 327 is likely to be deformed in such a way as to collapse next to the second rib-like part 326, and the first rib-like part 325 is least likely to be deformed. Therefore, when the force from the outside in the vehicle widthwise direction toward the center side is applied to the EA part 31, the side wall part 32 is deformed in such a way that the upper part of the side wall part 32 falls on the outer circumferential side. Accordingly, the side wall part 32 coming in contact with the battery module 50 can be prevented or suppressed.

Next, a relation between the cross 16 and the side frame 15 will be described. As illustrated in FIG. 5, in a section being cut by a plane perpendicular to the lengthwise direction surface, the first reference line L₁ passes through the inside of the cross upper plate part 161 (between the top surface and the bottom surface of the cross upper plate part 161). In such a structure, when the side frame 15 deformed by a side-impact collision or the like comes in contact with the cross 16, force transmitted from the first rib-like part 325 of the side frame 15 can be received by the cross upper plate part 161. The cross upper plate part 161 extends in a direction almost parallel to the acting direction of the external force transferred from the first rib-like part 325 and therefore is resistant to deformation by the external force. Accordingly, deformation of the cross 16 can be prevented or suppressed, and deformation of the side frame 15 can be suppressed; and therefore the side frame 15 coming in contact with the housed battery module 50 can be prevented or suppressed. Specifically, tolerance of the battery case 10 to a side-impact collision can be enhanced.

Furthermore, a structure in which the first reference line L₁ passes through the inside of the cross upper plate part 161 enables the height of the cross 16 to be lower than that of the side wall upper plate part 323 of the side frame 15. Accordingly, such a structure enables downsizing in the vertical direction and weight reduction of the battery case 10 while enhancing tolerance of the battery case 10 to a side-impact collision.

Furthermore, a thickness t_{c} of the cross upper plate part 161 is greater than the thickness t₁ of the first rib-like part 325. Such a structure enables enhanced rigidity of the cross 16 and therefore, even when a side-impact collision or the like occurs and the side frame 15 is deformed, enables enhancement of an effect of preventing or suppressing the deformed side frame 15 coming in contact with the battery module 50. Furthermore, the structure enables enhanced rigidity of the cross 16 and therefore enables prevention or suppression of deformation of the lower panel 11 joined to the cross 16 and the shared panel 19 joined to the lower panel 11 through the lower frame 18 (that is, the bottom part of the battery case 10). Accordingly, rigidity of the battery case 10 can be enhanced.

The side frame 15 is molded by extrusion molding. Specifically, the EA part 31 and the side wall part 32 are integrally molded. Such a structure enables an increased amount of absorbed energy compared with a structure in which the EA part 31 and the side wall part 32 are separate members. Specifically, when the EA part 31 and the side wall part 32 are separate members, clearance for installation is required between the EA part 31 and the side wall part 32. Then, the clearance does not contribute to energy absorption. On the other hand, the structure in which the EA part 31 and the side wall part 32 are integrally molded does not require clearance between the EA part 31 and the side wall part 32. Therefore, the sizes of the EA part 31 and the side wall part 32 can be increased by a length related to the clearance. Accordingly, an amount of absorbed energy can be increased. Further, the structure in which the EA part 31 and the side wall part 32 are integrally molded enables a reduced number of parts in the battery case 10 compared with the structure with separate members and enables reduced installation man-hours. Furthermore, a process and members (such as a bolt and a nut) for joining the EA part 31 to the side wall part 32 are not required.

While the embodiment of this disclosure has been described above, this disclosure is not limited to the embodiment.

For example, the sectional shape of the side frame 15 is not limited to the shape illustrated in each diagram. Further, another rib-like part may be provided inside the side wall part 32 in addition to the first rib-like part 325, the second rib-like part 326, and the third rib-like part 327. Further, the number of EA vertical plate parts 313 is not particularly limited.

Further, while a structure in which the side frame 15 is an extruded aluminum material has been described in the embodiment, the material of the side frame 15 is not limited to aluminum. Various types of extruded metal materials may be applied to the side frame 15 of the battery case 10 according to this disclosure.

Further, while an example of the battery case 10 having a box shape the upper side of which is open has been described in the embodiment, the battery case 10 is not limited to such a structure. For example, the battery case 10 may have a lid, and the upper side of the opening may be covered by the lid.

Further, while an example of applying laser welding to joining of members has been described in the embodiment, the method for joining members is not limited to laser welding, and, for example, a structure in which members are joined by friction stir welding (FSW) may be employed.

Further, while an example of the first rib-like part 325 and the second rib-like part 326 being placed between the side wall upper plate part 323 and the side wall lower plate part 324 has been described in the embodiment, the first rib-like part 325 or the second rib-like part 326 may be formed to serve as the side wall upper plate part or the side wall lower plate part. For example, the first rib-like part 325 may be formed to serve as the side wall upper plate part 323. Further, the second rib-like part 326 may be formed to serve as the side wall lower plate part 324.

A vehicular battery case according to this disclosure includes two side frames. The two side frames are separately placed in a first direction, extend in a second direction perpendicular to the first direction, and allow a battery to be housed in between. Each of the two side frames includes an energy absorption part and a side wall part. A space is formed inside the energy absorption part. The side wall part is provided on a vicinity side being a side closer to the counterpart side frame than the energy absorption part. A space is formed inside the side wall part. The energy absorption part includes a first plate-shaped part and a second plate-shaped part. The first plate-shaped part and the second plate-shaped part are separated from each other in a third direction perpendicular to the first direction and the second direction and extend in the first direction and the second direction. The side wall part includes a third plate-shaped part, a fourth plate-shaped part, a first rib-like part, and a second rib-like part. The third plate-shaped part extends in a direction crossing the first direction and in the second direction and is coupled with ends of the first plate-shaped part and the second plate-shaped part on the vicinity side. The fourth plate-shaped part extends in a direction crossing the first direction and in the second direction and is placed separately from the third plate-shaped part on the vicinity side of the third plate-shaped part. The first rib-like part and the second rib-like part extend in the first direction and the second direction. Ends of the first rib-like part and the second rib-like part on the vicinity side are coupled with the third plate-shaped part. Ends of the first rib-like part and the second rib-like part on an opposite side of the ends on the vicinity side are coupled with the fourth plate-shaped part. When viewed from the second direction, an extension of a center line of the first plate-shaped part in a thickness direction passes through an inside of the first rib-like part. An extension of a center line of the second plate-shaped part in a thickness direction passes through an inside of the second rib-like part.

This disclosure enables enhanced rigidity of the side frame. Specifically, when external force is applied to the energy absorption part from an outside in the second direction by a side-impact collision or the like, the external force is transmitted to the side wall part through the first plate-shaped part and the second plate-shaped part of the energy absorption part. Then, since the extension of the center line of the first plate-shaped part in the thickness direction passes through an inside of the first rib-like part, and the extension of the center line of the second plate-shaped part in the thickness direction passes through an inside of the second rib-like part, the external force transmitted to the side wall part through the first plate-shaped part and the second plate-shaped part is directly received by the first rib-like part and the second rib-like part of the side wall part. Therefore, deformation of the side wall part can be prevented or suppressed compared with a structure in which the first rib-like part and the second rib-like part are not provided. Specifically, rigidity of the side frame can be enhanced.

The aforementioned vehicular battery case may further include a bottom plate member. One end of the bottom plate member in the first direction may be joined to one of the two side frames. Another end of the bottom plate member in the first direction may be joined to another of the two side frames. A battery may be placeable on one surface of the bottom plate member in the third direction. A distance from a joint of the bottom plate member and the side wall part to the first rib-like part in the third direction may be greater than a distance from a joint of the bottom plate member and the side wall part to the second rib-like part. A thickness of the first rib-like part may be greater than a thickness of the first plate-shaped part.

With such a structure, the energy absorption part is more likely to be deformed than the side wall part. Accordingly, when external force is applied to the energy absorption part in such a way as to press the energy absorption part to the vicinity side, deformation of the energy absorption part absorbs energy by the external force and prevents or suppresses deformation of the side wall part by the external force. Accordingly, damage of the battery placed between the two side frames can be prevented or suppressed.

In the aforementioned vehicular battery case, the side wall part may further include a third rib-like part provided in such a way as to connect the first rib-like part to the second rib-like part.

The further inclusion of the third rib-like part by the side wall part enables enhanced rigidity of the side wall part and an increased amount of absorbed energy.

In the aforementioned vehicular battery case, one end of the third rib-like part may be coupled with a coupling part of the first rib-like part and the third plate-shaped part. Another end of the third rib-like part may be coupled with a coupling part of the second rib-like part and the fourth plate-shaped part.

Such a structure enables, by the third rib-like part, prevention or suppression of the side wall part being deformed in such a way as to fall on the battery side when external force causing the energy absorption part to move closer to the other side frame (causing the energy absorption part to move closer to the housed battery) is applied.

In the aforementioned vehicular battery case, a thickness of the second rib-like part may be less than a thickness of the first rib-like part.

Such a structure enables prevention or suppression of the side wall part being deformed in such a way as to fall to a side of the area where the battery is housed. Specifically, when force is applied to the side wall part from the energy absorption part, the second rib-like part thinner than the first rib-like part is more likely to be deformed than the first rib-like part. Then, when the second rib-like part is deformed in such a way as to collapse in the first direction and the first rib-like part is not deformed, or when an amount of deformation of the second rib-like part in the first direction is greater than an amount of deformation of the first rib-like part in the first direction, the side wall part is deformed in such a way that an end on a side far from the bottom plate member falls to a side opposite to a side on which the two side frames face each other. Specifically, in the structure in which the battery is housed between the two side frames, the side wall part is deformed in such a way as to fall in a direction in which the side wall part moves away from the battery.

In the aforementioned vehicular battery case, the two side frames may be extruded materials made of a metal material. The side wall part and the energy absorption part may be integrated.

Such a structure is not provided with clearance between the side wall part and the energy absorption part and therefore enables increased lengths of the side wall part and the energy absorption part in the first direction. Accordingly, an amount of energy absorbed by the side wall part and the energy absorption part can be increased. Further, a process and members for joining the side wall part to the energy absorption part are not required, and therefore a manufacturing cost can be reduced.

In the aforementioned vehicular battery case, a plurality of crosses each including a plate-shaped part extending in the first direction and the second direction may be placed between the two side frames. Ends of the cross in the first direction may face the third plate-shaped parts of the two side frames or may be in contact with the third plate-shaped parts. When viewed from the second direction, a center line of the first rib-like part in the thickness direction may pass through an inside of the plate-shaped parts of a plurality of the crosses.

With such a structure, when the side wall part is deformed and comes in contact with the cross, force transferred to the cross from the first rib-like part of the side wall part can be received by the plate-shaped part of the cross. Accordingly, rigidity of the battery case can be enhanced.

In the aforementioned vehicular battery case, a thickness of the plate-shaped part of the cross may be greater than a thickness of the first rib-like part.

Such a structure enables enhanced rigidity of the cross and therefore enables further enhanced rigidity of the battery case.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicular battery case comprising:
two side frames being separately placed in a first direction, extending in a second direction perpendicular to the first direction, and allowing a battery to be housed in between, wherein
each of the two side frames includes an energy absorption part inside which a space is formed, and a side wall part inside which a space is formed, the side wall part being provided on a vicinity side being a side closer to the counterpart side frame than the energy absorption part,
the energy absorption part includes a first plate-shaped part and a second plate-shaped part being separated from each other in a third direction perpendicular to the first direction and the second direction and extending in the first direction and the second direction,
the side wall part includes:
a third plate-shaped part extending in a direction crossing the first direction and in the second direction and being coupled with ends of the first plate-shaped part and the second plate-shaped part on the vicinity side;
a fourth plate-shaped part extending in a direction crossing the first direction and in the second direction and being placed separately from the third plate-shaped part on the vicinity side of the third plate-shaped part; and
a first rib-like part and a second rib-like part extending in the first direction and the second direction, and including ends on the vicinity side being coupled with the third plate-shaped part, and ends on an opposite side of the ends on the vicinity side being coupled with the fourth plate-shaped part, and,
when viewed from the second direction, an extension of a center line of the first plate-shaped part in a thickness direction passes through an inside of the first rib-like part, and an extension of a center line of the second plate-shaped part in a thickness direction passes through an inside of the second rib-like part.

2. The vehicular battery case according to claim 1, further comprising
a bottom plate member one end of which in the first direction is joined to one of the two side frames and another end of which in the first direction is joined to another of the two side frames, and on one surface of which in the third direction a battery is placeable, wherein
a distance from a joint of the bottom plate member and the side wall part to the first rib-like part in the third direction is greater than a distance from a joint of the bottom plate member and the side wall part to the second rib-like part, and
a thickness of the first rib-like part is greater than a thickness of the first plate-shaped part.

3. The vehicular battery case according to claim 1, wherein
the side wall part further includes a third rib-like part being provided in such a way as to connect the first rib-like part to the second rib-like part.

4. The vehicular battery case according to claim 3, wherein
one end of the third rib-like part is coupled with a coupling part of the first rib-like part and the third plate-shaped part, and
another end of the third rib-like part is coupled with a coupling part of the second rib-like part and the fourth plate-shaped part.

5. The vehicular battery case according to claim 2, wherein
a thickness of the second rib-like part is less than a thickness of the first rib-like part.

6. The vehicular battery case according to claim 1, wherein
the two side frames are extruded materials made of a metal material, and
the side wall part and the energy absorption part are integrated.

7. The vehicular battery case according to claim 1, wherein
a plurality of crosses each including a plate-shaped part extending in the first direction and the second direction are placed between the two side frames, ends of the cross in the first direction facing the third plate-shaped parts of the two side frames or being in contact with the third plate-shaped parts, and,
when viewed from the second direction, a center line of the first rib-like part in the thickness direction passes through an inside of the plate-shaped parts of the plurality of crosses.

8. The vehicular battery case according to claim 7, wherein
a thickness of the plate-shaped part of the cross is greater than a thickness of the first rib-like part.
